(19) United States
(12) Patent Application Publication
(10) Pub. No.: US 2015/0156132 A1
(43) Pub. Date: Jun. 4, 2015

(54) Determining Available User Interface Functionality Based on Backend Server Load

(71) Applicant: International Business Machines Corporation, Armonk, NY (US)

(72) Inventors: Nnaemeka I. Emejulu, Austin, TX (US); Andrew J. Lavery, Austin, TX (US); Ye Liu, Belmont, MA (US); Mario A. Maldari, Longmont, CO (US); Karthikeyan Ramamoorthy, Austin, TX (US)

(21) Appl. No.: 14/498,273

(22) Filed: Sep. 26, 2014

Related U.S. Application Data
(63) Continuation of application No. 14/094,894, filed on Dec. 3, 2013.

(51) Int. Cl. H04L 12/911

(52) U.S. Cl. CPC H04L 47/70

(57) ABSTRACT

An approach is provided for an information handling system to convey user interface functionality based upon a backend server load. The approach receives, over a computer network, a request from a client that utilizes a user interface. The approach further identifies a current resource utilization of a backend server resource that corresponds to the request and then transmits an indicator to the user interface with the indicator conveying the current resource utilization. In response to an overload condition being detected at the backend server resource, the approach transmits a substitute task recommendation to the user interface as a possible alternative request instead of the received request.

### BACKGROUND OF THE INVENTION

Identity manager systems enable large enterprises to automate life cycle management of user roles, identities, and access rights. These systems automate the creation, modification, re-certification, and termination of user privileges throughout the entire user cycle. Identity manager systems provide user accounts to authorized users on one or more resources to which identity manager resource adapters are connected. Identity management provides administration from a client interface in a Web browser that communicates through an HTTP server and application server using embedded HTTP transport.

In such large systems, under heavy load, user interfaces (UIs) can freeze and become unresponsive. When dealing with unavailable resources, end users might be unable to complete even the most basic of tasks (e.g., search, modify object, etc.).

### SUMMARY

An approach is provided for an information handling system to convey user interface functionality based upon a backend server load. The approach receives, over a computer network, a request from a client that utilizes a user interface. The approach further identifies a current resource utilization of a backend server resource that corresponds to the request and then transmits an indicator to the user interface with the indicator conveying the current resource utilization. In response to an overload condition being detected at the backend server resource, the approach transmits a substitute task recommendation to the user interface as a possible alternative request instead of the received request.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram depicting components utilized in determining available user interface (UI) functionality based on a backend server load;

FIG. 4 is a depiction of a flowchart showing the logic performed by the user interface that is being utilized by the end user;

FIG. 5 is a depiction of a flowchart showing the logic at the web site's backend to handle requests received from the user interface; and

FIG. 6 is a depiction of a flowchart showing the logic performed at the web site's backend to handle bulk requests received from an end user or other requestor.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

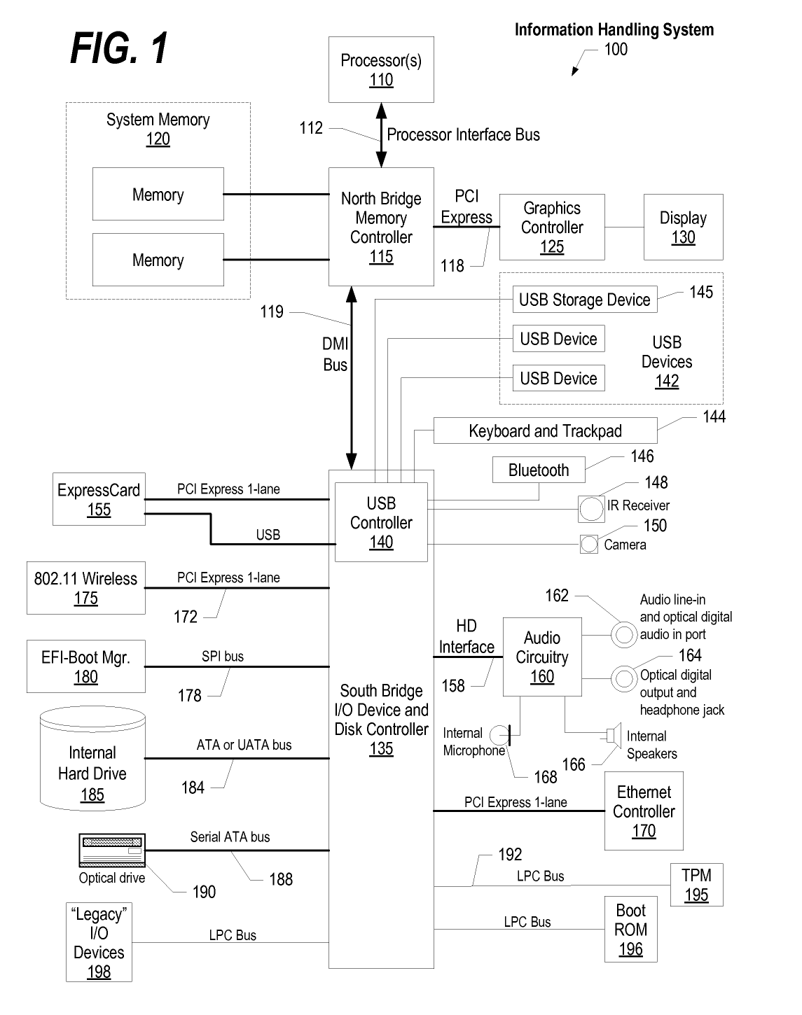

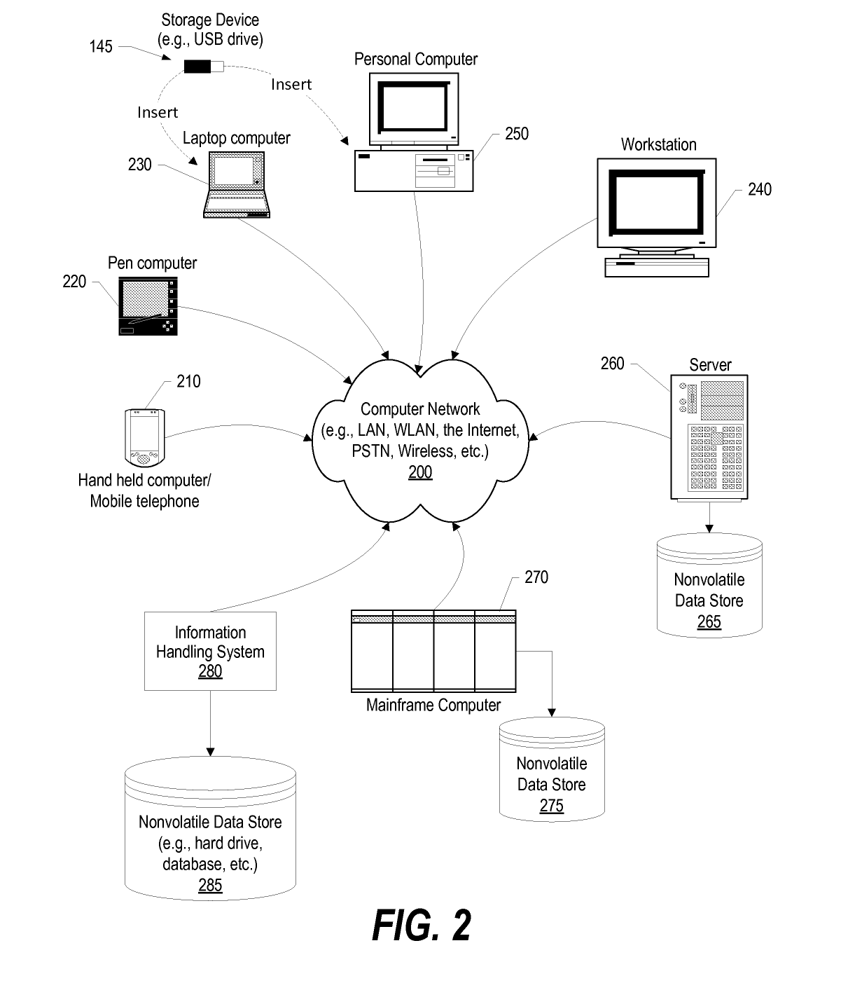

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

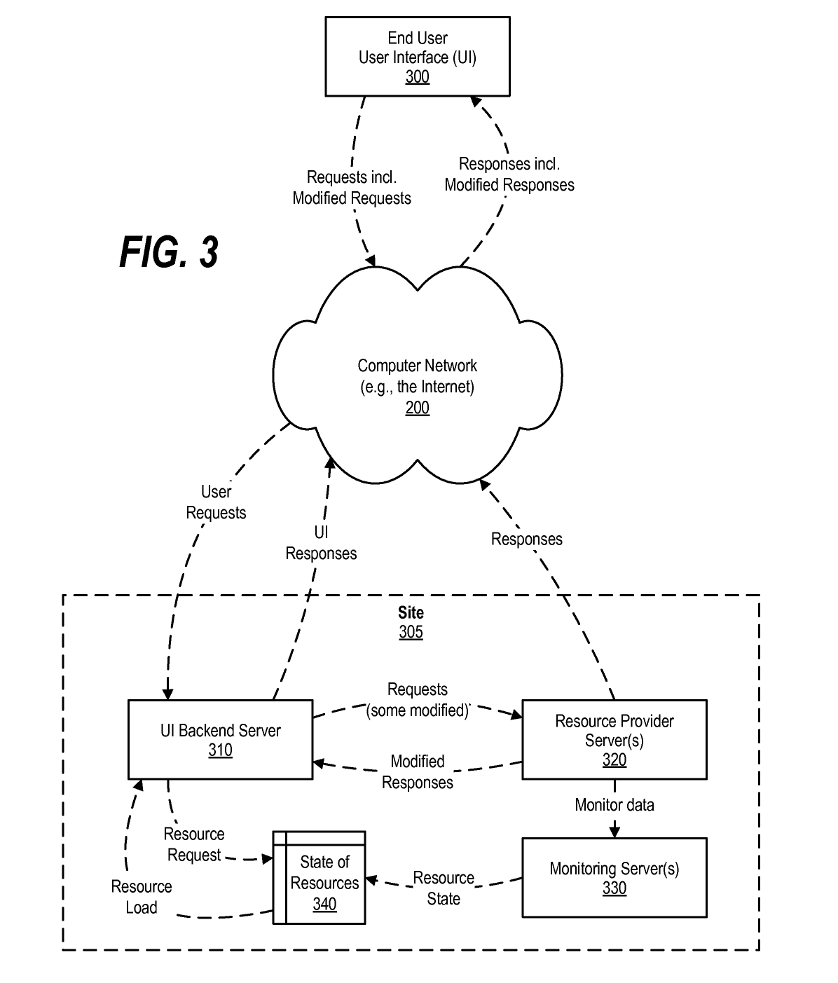

FIGS. 3-6 depict an approach that can be executed on an information handling system, to convey available user interface (UI) functionality based on a backend server load. The approach described herein suggests alternate activities (e.g., tasks, requests, etc.) that can be completed in faster time based on the utilization of the backend server resources. If the alternate activity is not acceptable, then the request is placed in a queue, however the user has been notified that backend server resources are overextended and, therefore, understands that the original request will take some time to complete. The approach may also suggest an alternate recommendation or request. For example, while performing search for a list of persons, the user may specify a search criteria that fetches all users who last name is “Smith.” After the server receives the search request, if the server determines it is over loaded, it may suggest an alternative that may result in a smaller number of users returned, such as “[A-M}* Smith.” In this manner, the backend server load condition is known to the user who is presented with alternative requests that are designed to be less taxing, and therefore better able to be performed by the backend server given current resource utilization levels. In one embodiment, the approach utilizes visual cues, such as a graphic feature that appears at the user interface, to proactively communicate load on server and the expected consequences of submitting bulk request during current load conditions.

FIG. 3 is a component diagram depicting components utilized in determining available user interface (UI) functionality based on a backend server load. The end user utilizes user interface 300, such as a dialog available on a client system or through a browser application. The end user transmits requests that are received and processed by web site 305.

Web site 305 includes user interface backend server process 310 that processes requests received from the user interface. Process 310 identifies the backend server resources that will be utilized to fulfill the received request. Process 310 retrieves a current resource load, or utilization, corresponding to the various resources that will be utilized from memory area 340 that is maintained by various monitoring servers 330. As shown, monitoring servers 330 receive monitor data from resource provider servers 320 and update the state of backend server resources by writing the utilization data to memory area 340.

If the user interface backend server detects an overload condition pertaining to a resource needed to fulfill the client's request, the user interface backend server sends a user interface response back to the client with the user interface response indicating a current resource utilization of the backend server resource. In addition, when an overload condition is detected, the user interface backend server can suggest an alternative request that the user can make instead of the original request with the user interface backend server previously identifying the alternative request as being a request that utilizes resources that are more readily available. The user at the client machine may decide to execute the original request, however the user will understand that the request may take some time to process given the overload condition that currently exists with regard to the backend server resource. On the other hand, the user may decide to make an alternative request, such as the request that was suggested by the user interface backend server, knowing that the alternative request is likely to be completed in less time than the original request would have taken to complete. The user interface backend server transmits requests, some of which may be modified requests as described above, to resource provider servers 320. The resource provider servers execute the request and utilize the backend server resources. The resource provider servers send responses back to the client based upon the submitted request.

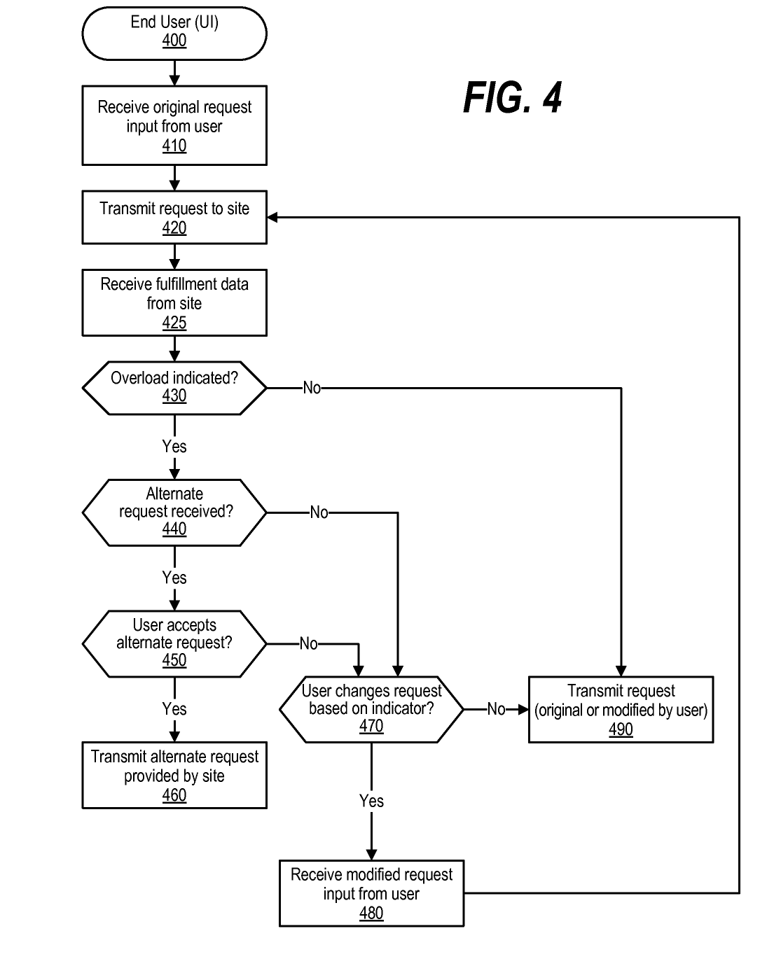

FIG. 4 is a depiction of a flowchart showing the logic performed by the user interface that is being utilized by the end user. End user processing commences at 400 whereupon, at step 410, the user interface process receives an original request from the user, or person, that is currently using the user interface. At step 420, the user interface process transmits the received original request to the web site for processing.

At step 425, the user interface process receives fulfillment data from the web site. The fulfillment data includes an indicator that conveys the current resource utilization corresponding to the backend server resource that is needed to process the request. In one embodiment, a visual cue, such as a color code, etc., is used to convey the current resource utilization in a graphical manner.

The user interface process determines if an overload condition currently exists with regard to the backend server resource (decision 430). If an overload condition currently exists, the decision 430 branches to the “yes” branch to handle the overload. The user interface process next determines if an alternate request suggestion was received from the web site (decision 440). For example, while performing search for a list of persons, the user may specify a search criteria that fetches all users who last name is “Smith.” After the server receives the search request, if the server determines it is over loaded, it may suggest an alternative that may result in a smaller number of users returned, such as “[A-M}* Smith.” If an alternate request suggestion was received, then decision 440 branches to the “yes” branch whereupon the user of the user interface is prompted as to whether the user would like to use the suggested modified request instead of the original request (decision 450). If the user would like to use the suggested modified request, then decision 450 branches to the “yes” branch whereupon, at step 460, the user interface process transmits the alternate request to the web site for processing.

Returning to decisions 440 and 450, if either an overload condition exists but an alternate request was not received (decision 440 branching to the “no” branch) or if the user does not accept the alternate request that was suggested by the web site (decision 450 branching to the “no” branch), then a decision is made by the user as to whether the user wishes to change the original request based on the overload condition that is currently in effect (decision 470). If the user wants to change the original request, then decision 470 branches to the “yes” branch whereupon, at step 480, the user interface receives a modified request that is input from the user and processing loops back to transmit the modified request to the web sit.

On the other hand, if either no overload condition was indicated by the website (decision 430 branching to the “no” branch) or if the user decides not to modify the request even though an overload condition has been noted (decision 470 branching to the “no” branch), then the user interface transmits the request to the web site for processing.

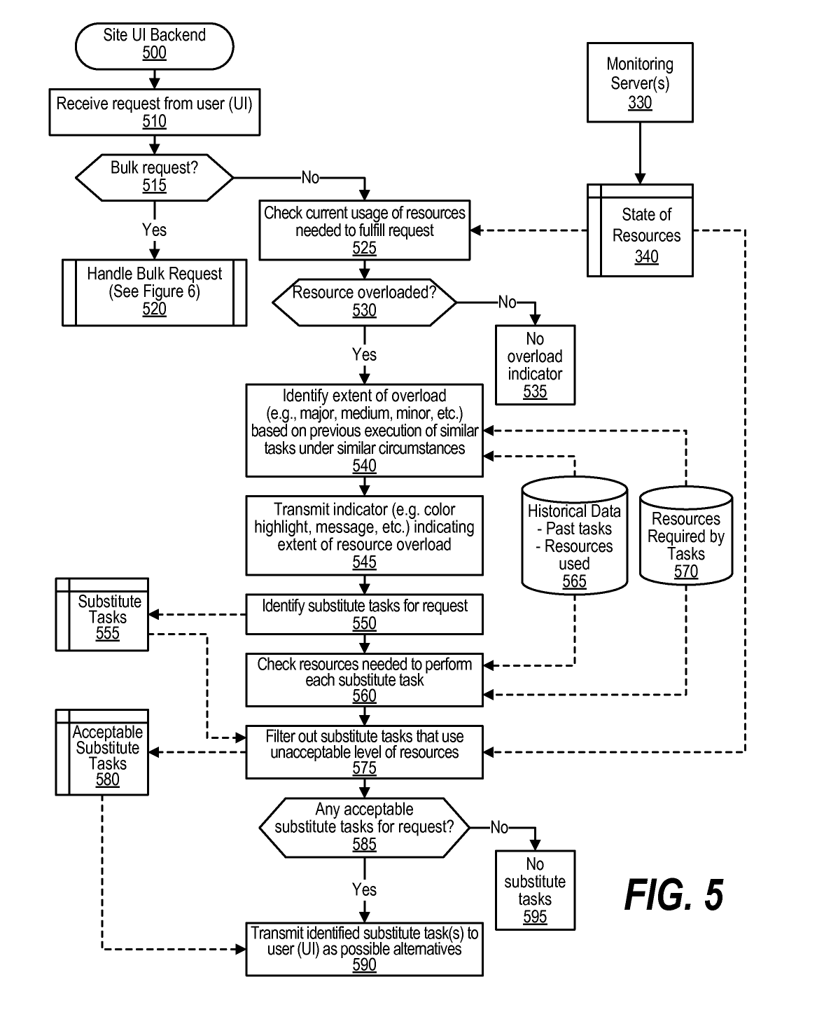

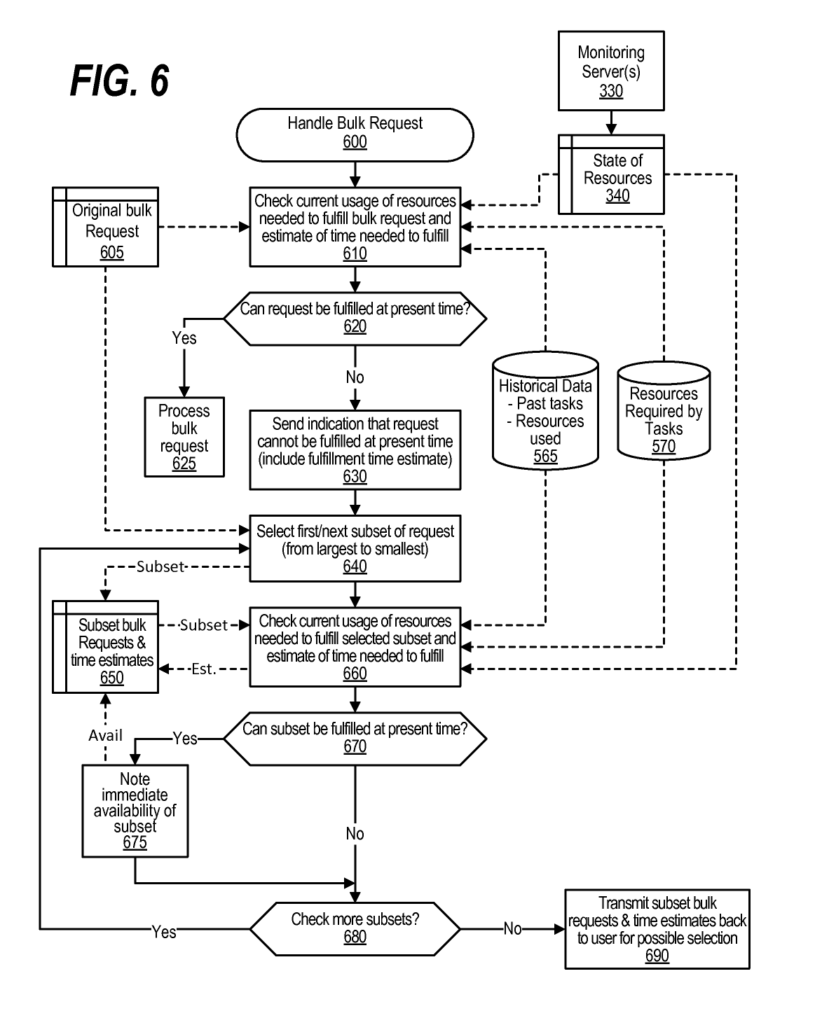

FIG. 5 is a depiction of a flowchart showing the logic at the web site's backend to handle requests received from the user interface. Backend processing of the request from the user interface commences at 500 whereupon, at step 510, the process receives the request from the user interface. A decision is made by the process as to whether the request is a bulk request (decision 515). If the request is a bulk request, the process branches to the “yes” branch whereupon, at predefined process 520, the backend server handles the bulk request (see FIG. 6 and corresponding text for processing details).

On the other hand, if the received request is not a bulk request, then decision 515 branches to the “no” branch where the process handles the non-bulk request. At step 525, the process checks the usage of backend server resources that are needed to handle the received request. As shown, monitor servers 330 monitor the various backend server resources and post the current state of such resources to memory area 340. The process reads this memory area containing the current state of backend server resources to check the current usage of the backend server resources. A decision is made by the process as to whether, based on the current resource usage level, the resource is overloaded (decision 530). In one embodiment, the process decides whether the resource is overloaded by comparing the resource usage level with a threshold. If the resource is not overloaded, the process branches to the “no” branch whereupon, at step 535, the process does not send an overload indicator to the user interface. On the other hand, if the resource is overloaded, then the process branches to the “yes” branch for further resource overload processing.

At step 540, the process identifies an extent of the overload, such as whether the overload condition is a major overload, a medium overload, or a minor overload. In one embodiment, process identifies the extent of the overload based on previous executions of tasks under similar system conditions and circumstances. In this embodiment, step 540 utilizes historical data from data store 565 that includes performance of past tasks as well as resources utilized during past performances as well as resource requirements data from data store 570 that includes the resources required to execute various tasks. At step 545, the process transmits an indicator, such as a graphical indicator (e.g., color, highlight, message, etc.) that conveys the extent of the resource overload being experienced by the backend server.

Because the resource is identified as overloaded, at step 550, the process identifies one or more substitute tasks, or requests, that the user might want to request as alternatives to the original user request. The process stores these substitute tasks in memory area 555. At step 560, the process checks the resources needed to perform each of the substitute tasks. In one embodiment, the process performs step 560 by utilizing the historical data from data store 565 as well as resource requirement data from data store 570. At step 575, the process filters out any of the substitute tasks that are unacceptable either because the substitute tasks utilize too many system resources or because the substitute tasks require resources that are also in an overload condition. The process stores substitute tasks that are not filtered (acceptable tasks or requests) in memory area 580. A decision is made by the process as to whether there are any acceptable substitute tasks that remain after the filtering (decision 585). If there are one or more substitute tasks, then the process branches from decision 585 to the “yes” branch whereupon, at step 590, the process transmits the identified substitute tasks (requests) to the user interface as possible alternative requests that the user can make instead of the original request. On the other hand, if there are no substitute tasks remaining after the filtering, then the process prs from decision 585 to the “no” branch whereupon, at step 595, no substitute, or alternative tasks, are sent to the user interface as possible alternatives to the user's original request.

FIG. 6 is a depiction of a flowchart showing the logic performed at the web site's backend to handle bulk requests received from an end user or other requestor. Processing commences at 600 whereupon, at step 610, the process receives original bulk request 605 and checks the current usage level of the backend server resources needed to fulfill each of the requests included in the bulk request as well as calculating a time estimate needed to fulfill each of the requests included in the bulk request. The process obtains the current usage level of the backend server resources from memory area 340 with the state of resources data being updated by monitoring servers 330. The process calculates the time estimates by utilizing historical data from data store 565 with the historical data having a record of past tasks performed under various operating conditions as well as the resources that were used and the time such tasks took to perform under such operation conditions. The process further obtains the resources needed by the various tasks from resource requirements data store 570.

A decision is made by the process as to whether the bulk request can be fulfilled at the present time given the resource utilizations (decision 620). If the request can be fulfilled at the present time, then decision 620 branches to the “yes” branch whereupon, at step 625, the process handles the bulk request. On the other hand, if the process determines that the request cannot be fulfilled in a timely manner at the present time, then decision 620 branches to the “no” branch for further processing.

At step 630, the process sends and indication to the user interface that the original bulk request cannot be fulfilled a the present time. In one embodiment, the indication also includes a time estimate corresponding to one or more of the requests included in the bulk request. A bulk request can include any number of request subsets. At step 640, the process selects the first of such subsets. In one embodiment, the process selects the subsets from the largest subset to the smallest subset. The selected subset of the bulk request is stored in memory area 650. At step 660, the process checks the current usage level of resources needed to fulfill the selected subset as well as calculates a time estimate of the amount of time needed to fulfill the selected subset. As previously described, the process checks current resource levels by reading data from memory area 340 that is updated by monitoring servers 330. In addition, the time estimate is calculated by utilizing historical data from data store 565 with the historical data having a record of past tasks performed under various operating conditions as well as the resources that were used and the time such tasks took to perform under such operation conditions. The process further obtains the resources needed by the various tasks from resource requirements data store 570. The estimated amount of time needed to execute the selected subset is added to memory area 650.

A decision is made by the process as to whether the selected subset of tasks (requests) can be fulfilled at the present time given the resource utilization (decision 670). If the selected subset can be fulfilled at the present time, then decision 670 branches to the “yes” branch whereupon, at step 675, the process notes the immediate availability of the selected subset in memory area 650. On the other hand, if the selected subset cannot be fulfilled at the present time, then decision 670 branches to the “no” branch whereupon the process bypasses step 675.

A decision is made by the process as to whether there are more subsets to process (decision 680). If there are more subsets to process, then decision 680 branches to the “yes” branch which loops back to select and process the next subset of the request. This looping continues until there are no more subsets to process, at which time decision 680 branches to the “no” branch whereupon, at step 690, the process transmits the subset of bulk requests, time estimates, and the indication of whether such subsets are available immediately from memory area 650 to the user interface. In this manner, the user can select subsets to be processed based upon the time estimates and indicators of which subsets are available for immediate handling by the backend server.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising a processor and a memory, of conveying user interface functionality based upon a backend server load, the method comprising:
receiving, over a computer network, a request from a client utilizing a user interface;
identifying a current resource utilization of a backend server resource that corresponds to the request;
transmitting an indicator to the user interface, wherein the indicator conveys the current resource utilization; and
in response to an overload condition with the backend server resource, transmitting a substitute task recommendation to the user interface as a possible alternative request instead of the received request.

2. The method of claim 1 further comprising:
retrieving a current usage of the backend server resource, wherein the current usage is computed by a monitoring server; and
identifying th current resource utilization based on the current usage.

3. The method of claim 1 further comprising:
identifying an extent of the overload condition, wherein the indicator further conveys the extent of the overload condition in a graphical manner.

4. The method of claim 1 further comprising:
in response to the overload condition:
identifying a first plurality of alternative tasks;
assessing one or more backend server resources used to perform each of the first plurality of alternative tasks;
removing one or more of the first plurality of alternative tasks based on the assessment revealing that the one or more alternative tasks consume an unacceptable level of backend server resources, the removal resulting in a second plurality of alternative tasks; and
transmitting the second plurality of alternative tasks to the user interface, wherein each of the second plurality of alternative tasks is a possible alternative request instead of the received request.

5. The method of claim 1 further comprising:
receiving a batch request, wherein the batch request is a plurality of requests that includes the request.

6. The method of claim 5 further comprising:
in response to the overload condition:
selecting a subset of the plurality of requests;
identifying an immediate availability of one or more of the plurality of requests based upon the current resource utilization corresponding to each of the plurality of requests; and
transmitting the selected subset of requests, including the immediate availability identifications corresponding to one or more of the requests, to the client.

7. The method of claim 5 further comprising:
in response to the overload condition:
calculating a completion time estimate corresponding to each of the plurality of requests; and
transmitting the completion time estimates corresponding to each of
